(19) United States
(12) Patent Application Publication
(10) Pub. No.: US 2016/0307168 A1
(43) Pub. Date: Oct. 20, 2016

(54) System and Method for Managing Products, Product Services, and Stakeholders over an Internet

(71) Applicant: ROBERT BOSCH GMBH, Stuttgart (DE)

(72) Inventors: Mansimar Aneja, T. Nagar (IN); Stefan Jungmayr, Ditzingen (DE); Ji Eun Kim, Pittsburgh, PA (US)

(21) Appl. No.: 15/103,083

(22) PCT Filed: Dec. 5, 2014
(86) PCT No.: PCT/EP2014/076669

§ 371 Date: Jun. 9, 2016

Related U.S. Application Data
(60) Provisional application No. 61/914,645, filed on Dec. 11, 2013.

(51) Int. Cl. G06Q 10/00; G06Q 50/06; G06Q 30/02; G06Q 40/04

(52) U.S. Cl. CPC G06Q 10/20; G06Q 40/04; G06Q 50/06; G06Q 30/0283

(57) ABSTRACT

A system and method for managing products, product services, and stakeholders, including communications between stakeholders, over an internet. The system and method includes an internet based portal and/or platform configured to support a number of stakeholders participating in the lifecycle of a product. The portal and/or platform provides solutions and services for all stages of a product life cycle. The portal and/or platform is configured to support internet connected devices and to support a plurality of services.

### CLAIM OF PRIORITY

This application claims priority to U.S. Provisional Application No. 61/914,645, which is entitled “System and Method for Managing Products, Product Services, and Stakeholders over an Internet,” and was filed on Dec. 11, 2013, the entire contents of which are hereby incorporated by reference herein.

### FIELD

This disclosure relates generally to product operation and product support, and more particularly to an internet portal and/or platform to manage access to product information by stakeholders and to manage interactions between interested parties including stakeholders.

### BACKGROUND

Existing support for operating and maintaining products, including devices, includes product information that is available through the internet. In some instances, a search engine can be used with the entry of the proper search terms to locate product information which can include user manuals, product specifications including parts lists, and maintenance manuals.

Many manufacturers provide links that are available through a manufacturer's website which direct a stakeholder to information generated and provided by the manufacturers. Stakeholders include businesses, organizations, and individuals having an interest in one or more devices information related to the operation and maintenance of a device. In fact, most products. goods, services, and products available today have associated web pages that are managed either by the manufacturer or by a third party. Most of these web pages, however, either have data or links to data that remains static and merely lists information about a model of a product. While the available data may accurately reflect features of the particular product model or class of products, the data does not represent the existence of and operating condition of a product in a user's home. In other words, this data mostly represents products in general but not instances of devices, wherein an instance is an occurrence a particularly distinct and identifiable product.

With the advent of the “Internet of Things”, certain products, typically electrical devices if properly configured, can be connected to an internet such that the connected device can be monitored and/or controlled through access to the “Internet”.

As used herein the term “internet” applies to all types of internets and networks, and combinations of internets and networks, including the “Internet” which uses a standard internet protocol suite (TCP/IP) which is accessed through a system of hyperlinks known as the “World Wide Web” or simply the “Web.” While the present disclosure describes applications directed to one embodiment using the “Internet” and “World Wide Web”, the present disclosure is not limited by these descriptions, and applies to other internets and to other means of accessing such internets.

In the “Internet of Things” the devices are uniquely identifiable objects whose status can be observed over the internet. Known internet based services for connected devices are point solutions that address mainly the operation and monitoring phase of the product lifecycle. In some instances, the services offered can include product information available through supporting web-portals. These known web-portals, are however, directed to an individual product or products provided by a single manufacturer.

What is needed is a single unifying portal to support devices that come from different domains. Also, a portal, that can support different stakeholders by providing only relevant information and services that are specific to their needs is also needed.

### SUMMARY

In accordance with one embodiment of the present disclosure, there is provided an internet solution center which provides product information and product services available through the web. The internet solution center is an online service and community internet-based platform to manage interactions between the various stakeholders of a particular product. In one embodiment, the stakeholders include the manufacturer, the installer, the end-user, and a user community, made of actual users of the product or in some case interested users of the product. The product/device is configured to be connected to the internet and upon connection becomes an active entity to support stakeholder interactions.

The internet solution center provides support to users of the center throughout the lifecycle of a product. The lifecycle includes buying, installation, operation, monitoring, diagnostics and maintenance, and improvements from user data and feedback.

Manufacturers that are registered users of the internet solutions center provide information related to a new device type, a class, a model, and other relevant static information including product serial number, other identification numbers, price, and any other information which the manufacturer believes would be useful to the stakeholders.

Registered installers and/or third party distributors associate themselves with product models or classes and with particular instances of the same product models. In this way, services directed to individual product instances, and not necessarily the product model or class, are offered by the installers and/or third parties.

In another embodiment, end users associate themselves with product instances. In this embodiment, a semantic knowledge database is provided and is directed to products and the different stake holders associated with the products. In another embodiment, a graphical depiction is provided to illustrate relationships between users of the same products, common installers, and problems encountered whether similar or dissimilar.

The services offered to end users and also to other stake holders by the internet solution center are made particularly useful by utilizing the participation of all the stake-holders or community members combined with the functionality offered by the connected products.

### BRIEF DESCRIPTION OF THE DRAWINGS

FIG. 1 is schematic block diagram of an architecture for a web solution center including an internet based product management system.

FIG. 2 is a schematic block diagram illustrating a procedure configured to provide the internet based product management system of FIG. 1.

FIG. 3 is a flow diagram illustrating a process for internet based product management.

### DESCRIPTION

For the purposes of promoting an understanding of the principles of the embodiments disclosed herein, reference is now made to the drawings and descriptions in the following written specification. No limitation to the scope of the subject matter is intended by the references. The present disclosure also includes any alterations and modifications to the illustrated embodiments and includes further applications of the principles of the disclosed embodiments as would normally occur to one skilled in the art to which this disclosure pertains.

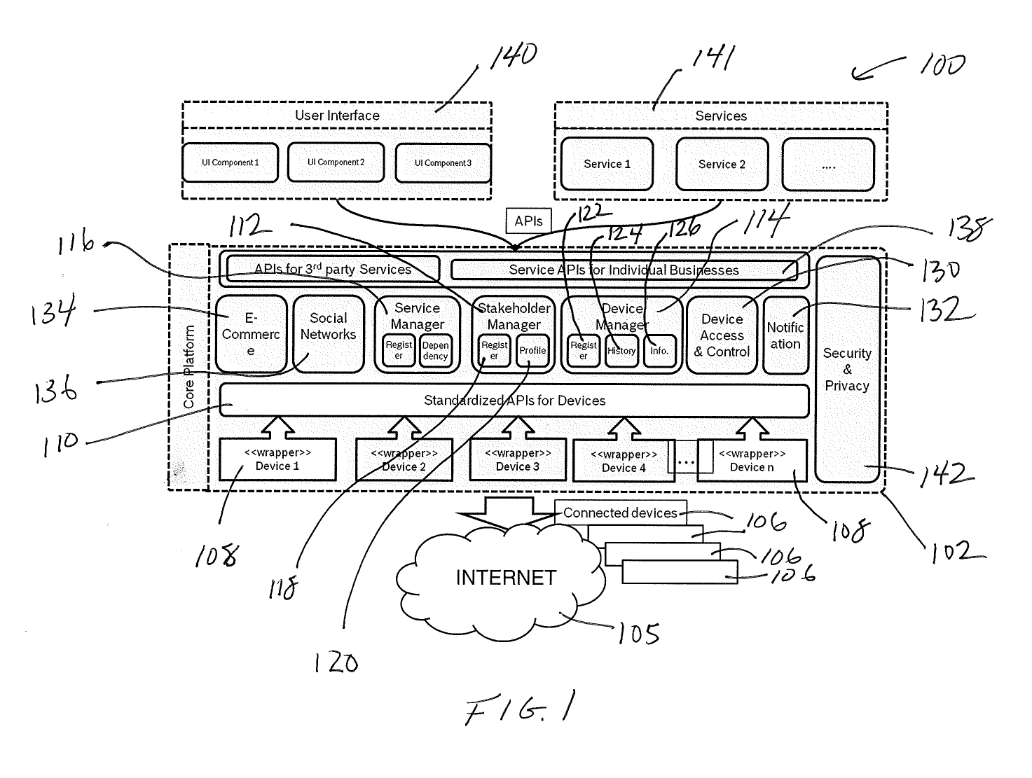

FIG. 1 illustrates a schematic block diagram of internet solutions center 100 including an internet based product management system 102, here labeled as a core platform. Other embodiments of the product management system 102 are possible including those where the components described therein are separately located. The products management system 102 may be implemented on one or more servers. The product management system 102 is connected via an internet 105 to a plurality of connected devices 106. Each of the plurality of connected devices 106 is located at user's or users' point of placement and is specifically identifiable to distinguish one of the plurality of connected devices from any of the other plurality of connected devices. Each of the plurality of connected devices 106 provides one or more functions under control of the user(s).

The plurality of connected devices 106, in different embodiments, are connected through a network (not shown) which in different embodiments includes any number of different types of networks including one or more wide area network(s), intranets(s) or any other of distributed networks, such as a local area network, a satellite communication network, a public network, or a metropolitan area network. Transmission of information to and from connected devices 106 to the product management system 102, in one or more embodiments, includes a wired or wireless link or any other known or later developed element that is capable of supplying electronic data to and from the connected elements.

Each one of the plurality of connected devices 106 is operatively coupled to one of a plurality of wrappers 108. A wrapper 108 includes a basic interface that enables a connected device 106 to communicate with the various functions provided by the product management system 102. Each of the plurality of wrappers 108 includes software that functions to enable communication between the possible different types of connected devices 106 and the product management system 102. While the wrappers are illustrated as being a component of the product management system 102, in other embodiments, a wrapper 108 is implemented in a connected device itself.

The product management system 102 also includes a Standardized Application Programming Interface (API) for Devices component 110 which includes software configured to provide access by a stakeholder to the connected devices 106, which in one embodiment are heterogeneous devices accessible via the wrappers 108. The API for devices component 110 is also configured to include a semantic representation of each of the possible connected devices 106. The semantic representations are derived by identifying a device's inherent functions and parts content by its type or meaning.

The product management system 102 includes a plurality of individual software building blocks that provide for the registration and management of users (including stakeholders), devices and services. These building blocks are considered core building blocks and include a stakeholder manager component 112, a device manager component 114, and a service manager component 116. The stakeholder manager component 112 is configured to provide a register component 118 for registering at least the identity of a particular stakeholder, and a profile component 120 which is configured to include information relevant to the particular stakeholder including an identification of the connected device 106 associated with the identified stakeholder. The device manager component 114 is configured to provide for registration of a connected device through a registration component 122, to provide a history of a registered device through a history component 124, and to provide information of the connected device through an information component 126.

In one embodiment, the internet solutions center 100 is configured to provide remote monitoring and control of connected devices 106 and notification for updates of the status of connected devices including any abnormal behavior of the connected devices. These functions are provided by a device access and control component 130 and a notification component 132. In another embodiment, additional advance services are implemented in a services component 141 together with device access and control component 130, service manager component 116, a notification component 132 and device information component in 126 which includes a diagnostics component, a maintenance component, and a scheduling of events component.

The software architecture of the product management system 102 is configured to provide a common and unified service and community infrastructure for various stakeholders including home users, installers and other individuals or business entities having a legitimate interest in the connected devices 106. An e-commerce component 134 provides device, spare parts, applications and services for sale, rent, or license. A social networks component 136 provides a community feature to enable peer to peer support for trouble shooting device malfunction.

A service APIs for an individual businesses component 138 is a software abstraction that allows 3^{rd} party partners and/or developers or business developers to provide additional value added services not included initially in the internet solutions center 100. For example, each business unit, organization, or entity develops a product specific diagnostic service with domain knowledge. As a consequence, business units developing new or improved products, in one embodiment, provide diagnostic services as such products become available. As a result, the internet solutions center 100 includes the capability of providing information and support not only over the lifetime of a product, but also for providing new products.

Also, the service APIs 138 is accessible by one or more user interface devices 140 such as a smart phone, a smart television, a web browser in PC, or a dedicated electronic device. A services component 141 enables remote access through the World Wide Web to the product management system 102. In one embodiment, the user interface 140 includes a web browser. A security and privacy component 142 includes software building blocks to provide necessary authentication, authorization and privacy settings for the user, devices, and services.

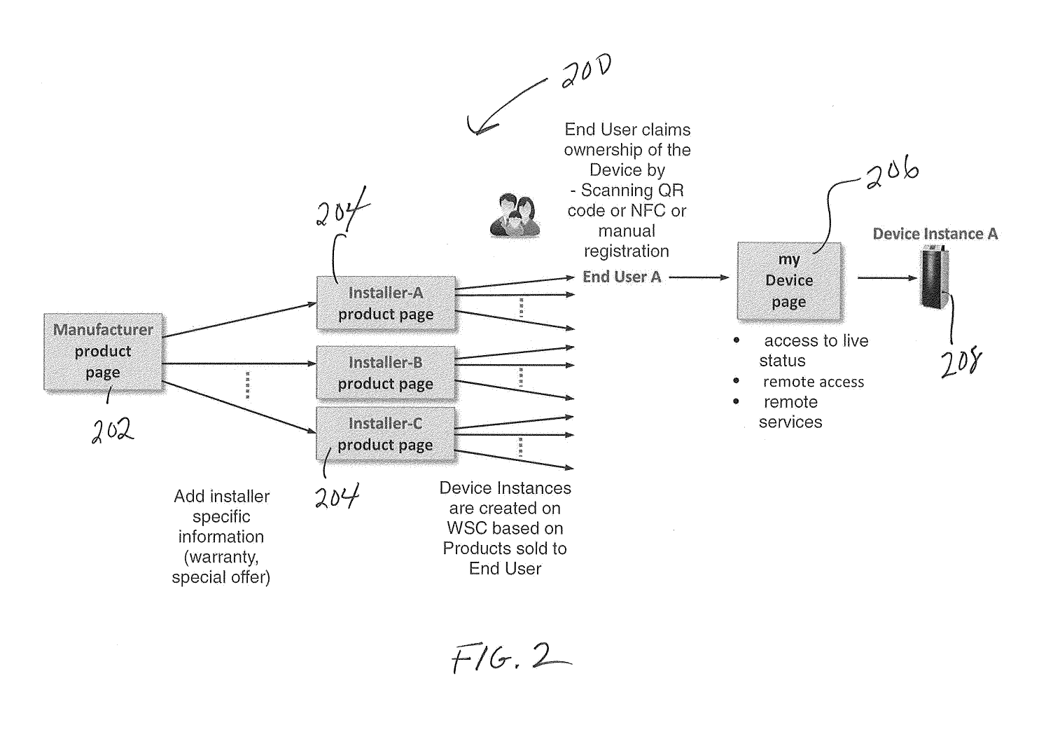

FIG. 2 illustrates one embodiment of a procedure 200 to associate stakeholders with products. As illustrated in FIG. 2, the manufacturer provides a manufacturer product page 202 which when incorporated into the system 102 exists as a virtual entity on the internet solutions center 100. The manufacturer product page includes any information the manufacturer finds relevant to the product, which in one embodiment, includes information related to device operation, device upkeep, and device troubleshooting in the event of a malfunction. The information is updated by the manufacturer.

The manufacturer generates the product page 202 to which installers or other service providers (companies or individuals) associate themselves. In one embodiment, the product page 202 is located in the stakeholder manager component 112 of FIG. 1. Other locations of the product page 202 are possible within the system 102. As seen in FIG. 2, one or more installers each provide a product page 204 directed to the specific product page provided by the manufacturer. The installers are not limited those companies that manufacture and install products, but also include entities that sell products or that maintain products but without being a manufacturer. In this configuration, the installers provide a product page including additional services, or even additional products which are included in the installation of the manufacturer's product. The installer product page includes installer specific information such as warranty information, special offer information, recommended maintenance schedules, appointment scheduling, and location information related to the product offered or installed.

Individual device instances are provided upon installation of the product in the end user's facility or home. Each of the device instances are provided on an internet solution center selected according to the products sold to the end user. Once the device instances are provided, each of the device instances is summarized into a device page 206 which is associated with a specific device instance 208. The device page is established in one embodiment, by scanning a product identification cade, such as a quick response code (QR) or near field communication code (NFC), or through manual registration available through the device page. Once a device is registered, an end user can make service requests to an associated installer or other service provider.

The device page 206 is accessible by the user through the user interface 140 of FIG. 1 and provides access to information provided by the manufacturer and/or installer. The device page 206 also provides to the installer and/or manufacturer access to a live operating status of the device, remote access to a device for updating features or accessing information stored on the device, or for providing remote services such as turning devices on or off, scheduling device operations, or updating device configurations. In one embodiment, internet based products management system 102 receives monitoring data from the device on a continuous or periodic basis. The monitoring data at least includes a status of the device. The notification component 132 may send a notification to an end-user, a manufacturer, or a service provider if the monitoring data suggests that there has been an error or malfunction of the device. In one embodiment, the products management system 102 may be configured to aggregate monitoring data from many device instances and to transmit the aggregated monitoring data to the manufacturer of the devices for analysis.

In another embodiment, since individual device instances are associated with an end user or end users, installers and/or manufacturers only provide services or functions upon receipt of a request submitted by a user. Once the end user indicates that the particular service or function is requested, the installer and/or manufacturer provides the service/function and bills the end user. In this embodiment, a particular device instance is dynamically connected to services and/or functions provided by the manufacturer/installer upon selection by the user. A service history or a maintenance history may be kept and displayed on the device page 206. In another embodiment, end users, manufacturers or service providers may use the device page 206 to control an operation of the device.

By associating stake holders with products, one or more communities of installers and end users interact, not only individually, but also collectively, to solve problems or propose improvements. Consequently, the disclosed embodiments provide a social network of people and things.

In one embodiment, the manufacturer and the end-user are the only stakeholders. In other embodiments, additional stakeholders become part of the internet solutions center depending on the configuration of the internet solutions center established by the manufacturers or maker of the internet solutions center. Additional stakeholders are included depending on the value chains provided by the businesses or individuals interested in becoming part of the internet solutions center.

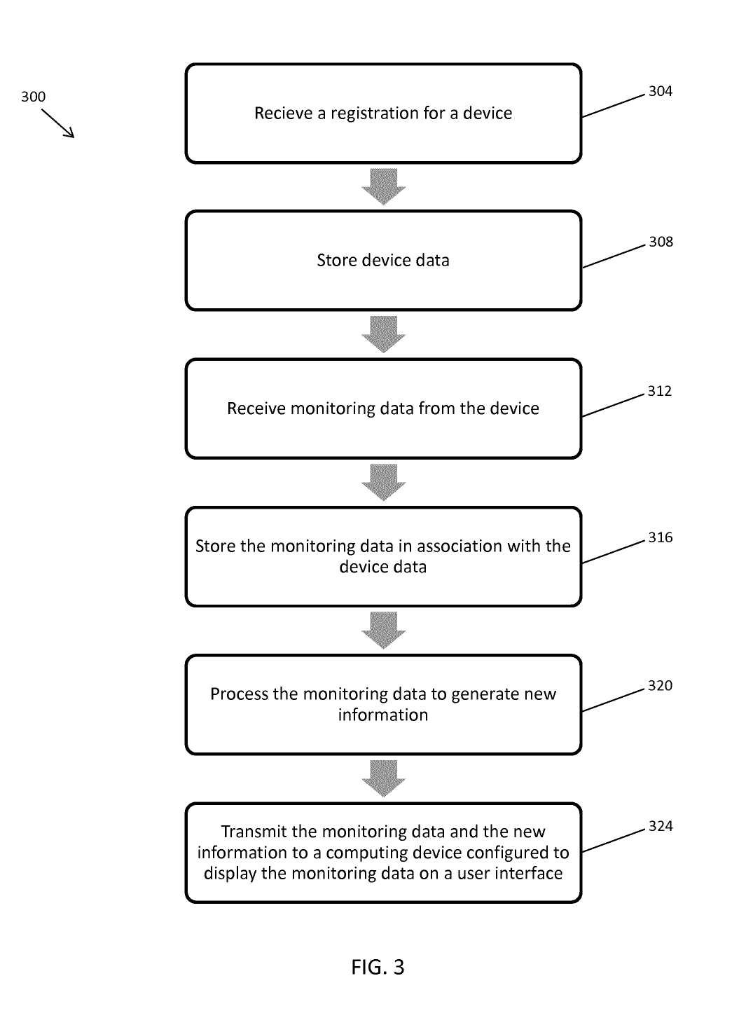

FIG. 3. depicts a process 300 for product management. This process may be performed by a server that embodies the internet based products management system 102. The process begins by receiving a registration for a device (block 304). The server receives the device registration over a network from, for example an end-user or installer. Next, the process 300 stores device data (block 308). The device data includes a product model identifier and a product instance identifier for the device and is stored in a memory of the server. This device data generally corresponds to a device page, such as the device page 206. Next, the process 300 receives monitoring data from the device (block 312). The server receives monitoring data from the device over the network on a continuous or periodic basis during the lifespan of the device. The monitoring data at least includes a status of the device. Next, the process 300 stores the monitoring data in association with the device data (block 316). In this way, the monitoring data may recalled by the device page corresponding to the device data. Next, the process 300 optionally processes the monitoring data in order to generate new information (block 320). For example, in one embodiment the management system 102 processes the monitoring data to generate an energy cost prediction based on the monitoring data for the past week. Next, the process 300 transmits the monitoring data to a computing device configured to display the monitoring data and the new information on a user interface (block 324). The monitoring data and the new information are sent by the server over the network to the computing device so that an end-user or stakeholder can review the monitoring data from the device page.

It will be appreciated that variants of the above-disclosed and other features and functions, or alternatives thereof, may be desirably combined into many other different systems, applications or methods directed to and used by a wide variety of stakeholders. Various presently unforeseen or unanticipated alternatives, modifications, variations or improvements may be subsequently made by those skilled in the art that are also intended to be encompassed by the following embodiments. The following embodiments are provided as examples and are not intended to be limiting.

### Embodiment 1

An internet portal/platform configured to support the requirements of different stakeholders during the entire lifecycle of a product. Each stakeholder identified as a separate entity within the platform.

### Embodiment 2

An internet portal configured to provide support to different stakeholders for different product classes or models and to support specific product instances (e.g.: a dishwasher owned by User A is a separate instance from the same model of the dishwasher owned by User B) as a separate and active entity within the platform.

### Embodiment 3

A portal/platform configured to provide transferability of ownership, access rights, device access, services and/or solutions across stakeholders using identification technologies such as QR/barcode and NFC.

### Embodiment 4

A portal configured to provide registration and configuration solutions for the devices and services supported using identification technologies such as QR/barcode, NFC.

### Embodiment 5

A portal configured to support services and/or solutions and to maintain different stakeholder relationships in regard to these services and/or solutions.

### Embodiment 6

A portal configured to recommend services and/or solutions based on the different stakeholder profiles and relationships and/or device dependencies.

### Embodiment 7

A portal configured to provide social interaction (people and things) between stakeholders and also between products and stakeholders using social interaction technologies such as Facebook, Twitter, chat technologies, text messaging, E-mail technologies, voice mail, and direct voice communication.

### Embodiment 8

A platform configured to provide a mechanism for third parties to develop solutions and/or services within the portal.

### Embodiment 9

A platform configured to provide a mechanism for stakeholders to develop solutions and/or services within the portal.

### Embodiment 10

A portal configured to provide multiple modes of interaction such as speech, text, touch and through multiple types of devices such as a phone, a personal computer, a tablet device, and a television.

### Embodiment 11

A portal configured to support participation by a plurality of stakeholders and to utilize a collective intelligence that is provided by the stakeholder including for example discussions, ratings, and solutions.

### Embodiment 12

A portal configured to support electronic commerce as a part of a service, product, or parts component.

What is claimed is:

1. A method for product management comprising:
receiving a registration for a device at a server over a network;
storing device data including a product model identifier and a product instance identifier for the device in a memory of the server;
receiving monitoring data from the device at the server over the network, the monitoring data at least including a status of the device;
storing the monitoring data in the memory of the server in association with the device data; and
transmitting with the server the monitoring data to a computing device that is in communication with server over the network and configured to display the monitoring data on a user interface.

2. The method of claim 1, further comprising:
processing the monitoring data with a processor of the server; and
transmitting the processed monitoring data to the computing device.

3. The method of claim 1, the processing further comprising:
identifying with the processor energy usage of the device with reference to the monitoring data; and
generating with the processor an energy cost prediction with reference to the monitoring data.

4. The method of claim 1, further comprising:
detecting an error associated with the device based on the monitoring data with a processor of the server; and
transmitting with the server a notification of the error to the computing device.

5. The method of claim 1, further comprising:
receiving a control request at the server from the computing device; and
transmitting with the server a control command to the device, the device being configured to receive the control command and change an operating mode in response to the control command.

6. The method of claim 1, further comprising:
storing service provider data corresponding to services for the device in association with the device data in the memory of the server, the service provider data relating to services offered by a service provider;
transmitting with the server the service provider data to the computing device to enable an end-user to view the services offered by the service provider;
receiving a service request at the server from the computing device; and
transmitting with the server the service request to another computing device to enable the service provider to view the service request.

7. The method of claim 1, further comprising:
storing service history data in association with the device data in the memory of the server, the service history data relating to services that have been performed on the device by service providers of the device ; and
transmitting with the server the service history data to the computing device over the network.

8. The method of claim 1, further comprising:
receiving registrations for a plurality of devices at the server over the network;
storing device data for each of the plurality of devices in the memory of the server, the device data including a product model identifier and a product instance identifier for each of the plurality of devices;
receiving monitoring data from each of the plurality of devices at the server over the network, the monitoring data at least including a status of the plurality of devices;
storing manufacturer data in the memory of the server in association with the device data, the manufacturer data being related to a manufacturer of the plurality of devices;
aggregating the monitoring data from each of the plurality of devices with a processor of the server; and
transmitting with the server the aggregated monitoring data to another computing device to enable the manufacturer to view the aggregated monitoring data.

9. A system for product management comprising:
a server having a processor, a memory, and a network device configured to transmit and receive data over a network, the server being configured to:
receive a registration for a device;
store device data including a product model identifier and a product instance identifier for the device in the memory;
receive monitoring data from the device over the network, the monitoring data at least including a status of the device;
store the monitoring data in the memory in association with the device data; and
transmit the monitoring data to a computing device that is in communication with server over the network and configured to display the monitoring data on a user interface.

10. The system of claim 9, the server being further configured to:
process the monitoring data with the processor; and
transmit the processed monitoring data to the computing device.

11. The system of claim 9, the server being further configured to:
identify with the processor energy usage of the device with reference to the monitoring data; and
generate with the processor an energy cost prediction with reference to the monitoring data.

12. The system of claim 9, the server being further configured to:
detect an error associated with the device based on the monitoring data with the processor; and
transmit a notification of the error to the computing device.

13. The system of claim 9, the server being further configured to:
receive a control request from the computing device; and
transmit a control command to the device, the device being configured to receive the control command and change an operating mode in response to the control command.

14. The system of claim 9, the server being further configured to:
store service provider data corresponding to services for the device in association with the device data in the memory;
transmit the service provider data to the computing device to enable an end-user to view services offered by the service provider for the device;
receive a service request from the computing device; and
transmit the service request to another computing device to enable the service provider to view the service request.

15. The system of claim 9, the server being further configured to:
store service history data in association with the device data in the memory, the service history data relating to services that have been performed on the device by service providers of the device; and
transmit the service history data to the computing device over the network.

16. The system of claim 9, the server being further configured to:
receive registrations for a plurality of devices over the network;
store device data for each of the plurality of devices in the memory, the device data including a product model identifier and a product instance identifier for each of the plurality of devices;
receive monitoring data from each of the plurality of devices over the network, the monitoring data at least including a status of the plurality of devices;
store manufacturer data in association with the device data in the memory, the manufacturer data being related to a manufacturer of the plurality of devices;
aggregate the monitoring data from each of the plurality of devices with a processor of the server; and
transmit the aggregated monitoring data to another computing device to enable the manufacturer to view the aggregated monitoring data.
